(19) United States
(12) Patent Application Publication
(10) Pub. No.: US 2019/0021542 A1
(43) Pub. Date: Jan. 24, 2019

(54) MULTI-CUP DRIP COFFEE MAKER

(71) Applicant: Coffeeland Co., Ltd., Changhua County (TW)

(72) Inventor: Kevan Chen, Changhua County (TW)

(21) Appl. No.: 15/653,761

(22) Filed: Jul. 19, 2017

(51) Int. Cl. A47J 31/44; A47J 31/40; A47J 31/06; A47J 31/24

(52) U.S. Cl. CPC A47J 31/44; A47J 31/40; A47J 31/4482; A47J 31/24; A47J 31/0647

(57) ABSTRACT

A multi-cup drip coffee maker includes a displacing mechanism mounted inside a casing. The casing has a user interface mounted on a front panel of the casing. A first driving mechanism is mounted on an inner wall of one of two side panels of the casing, and a second driving mechanism and a control unit are mounted on an outer wall of the side panel. The first driving mechanism drives a coffee outlet seat on the displacing mechanism to move between the two side panels. The second driving mechanism drives the displacing mechanism to oscillate forward and backward. The control unit is electrically connected to the user interface and the first and second driving mechanisms, and drives the first and second driving mechanisms to individually or both operate according to a configuration signal from the user interface to fulfill time-efficient brewing of multiple cups of drip coffee with enhanced drip coffee quality.

### BACKGROUND OF THE INVENTION

### 1. Field of the Invention

The present invention relates to a drip coffee maker and, more particularly, to a multi-cup drip coffee maker allowing multiple cups to be placed thereon to continuously receive drip coffee with different flavors.

### 2. Description of the Related Art

Coffee and tea are the refreshing hot drinks for people after they get up in the morning. Recently, coffee becomes a globally popular beverage due to penetration of westernized lifestyle everywhere. Coffee shop chain prospers rapidly in answer to that call.

The ways of making drip coffee can be classified as manual drip and automatic drip. Given the manual drip as an example, hot water seeps through the ground coffee and the paper filter placed on an empty cup, and is then collected in the cup. As we know, ground coffee of different flavors needs to have different ways to brew drip coffee. Although releasing flavors of ground coffee to the maximum extent, manual drip fails to be effective in coffee brewing to make both ends of flavor and quality meet.

Given the automatic drip as an example, ground coffee is filled in a container, which is placed on a drip coffee maker, such that steam pressure of hot water entering the container brews coffee and the drip coffee is collected in an empty cup. Even though automatic drip is faster than manual drip in terms of brewing drip coffee, automatic drip can provide one cup of drip coffee at a time. Meanwhile, automatic drip fails to fully release flavors of ground coffee. Under the circumstance, drip coffee made by automatic drip at most can be taken for refreshing purpose without having the enjoyable coffee flavors therein.

### SUMMARY OF THE INVENTION

An objective of the present invention is to provide a multi-cup drip coffee maker, which continuously and automatically brews multiple cups of coffee, provides different ways of pouring hot water over ground coffee by using the driving mechanism in the coffee maker to drive a coffee outlet seat to move and/or oscillate, thereby fulfilling advantages of coffee flavor similar to manually brewed coffee and reduced coffee brewing time for assurance of enhanced coffee brewing efficiency and quality of brewed coffee.

To achieve the foregoing objective, the multi-cup drip coffee maker includes a casing, a user interface, a displacing mechanism, a first driving mechanism, a second driving mechanism and a control unit.

The casing has a front panel, a first side panel, a second side panel, a receiving chamber and a filtering cup shelf.

The second side panel is opposite to the first side panel.

The receiving chamber is defined between the first side panel and the second side panel.

The filtering cup shelf is mounted inside the receiving chamber.

The user interface is mounted on the front panel.

The displacing mechanism is pivotally mounted on inner walls of the first side panel and the second side panel and has a coffee outlet seat movably mounted on the displacing mechanism to be moveable between the first side panel and the second side panel.

The first driving mechanism is mounted on the inner wall of the first side panel and is connected with the displacing mechanism to drive the displacing mechanism and the coffee outlet seat to be movable left and right between the first side panel and the second side panel.

The second driving mechanism is mounted on an outer wall of the first side panel, and is pivotally connected with the displacing mechanism to drive the displacing mechanism and the coffee outlet seat to oscillate forward and backward.

The control unit is mounted on the outer wall of the first side panel, and is electrically connected to the user interface, the first driving mechanism and the second driving mechanism, configures multiple positioning points along a longitudinal direction of the filtering cup shelf with each positioning point corresponding to a location for a corresponding filtering cup to be placed, receives a configuration signal sent from the user interface, and transmits a driving signal to the first motor drive according to the configuration signal to drive the first driving mechanism to operate to drive the displacing mechanism for the displacing mechanism to drive the coffee outlet seat to move to any one of the multiple positioning points or transmits another driving signal to drive the second driving mechanism to operate to drive the displacing mechanism for the displacing mechanism to drive the coffee outlet seat to oscillate forward and backward with respect to a corresponding positioning point.

As can be seen from the foregoing structure, after users configure the type of coffee to be brewed and the way of coffee brewing through the user interface, the user interface transmits the configuration signal to the control unit, and the control unit sends the driving signal according to the configuration signal to the first driving mechanism or the second driving mechanism for individual or dual operation. Hence, the multi-cup drip coffee maker can continuously brew multiple cups of coffee and pour hot water over ground coffee in the filtering cup as configured in the way of coffee brewing to implement coffee brewing similar to manual coffee brewing and continuous brewing of multiple cups of coffee, thereby reducing coffee brewing time and raising quality of brewed coffee.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a multi-cup drip coffee maker in accordance with the present invention;

FIG. 2 is a schematic front view of a multi-cup drip coffee maker in accordance with the present invention with a casing thereof removed and a displacing mechanism exposed;

FIG. 3 is a schematic front view of the multi-cup drip coffee maker in FIG. 2 with the casing thereon;

FIG. 4 is a side view of the multi-cup drip coffee maker in FIG. 3;

FIG. 5 is a schematic view showing a first operation of a user interface of the multi-cup drip coffee maker in FIG. 3;

FIG. 6 is a schematic view showing a second operation of the user interface in FIG. 3;

FIG. 7 is a schematic view showing a third operation of the user interface in FIG. 3;

FIG. 8 is a schematic view showing a fourth operation of the user interface in FIG. 3;

FIG. 9 is a schematic view showing a first dripping action of the displacing mechanism in FIG. 2;

FIG. 10 is a schematic view showing a second dripping action of the displacing mechanism in FIG. 2;

FIG. 11 is a schematic view showing a third dripping action of the displacing mechanism in FIG. 2; and

FIG. 12 is a schematic view showing a fourth dripping action of the displacing mechanism in FIG. 2.

### DETAILED DESCRIPTION OF THE INVENTION

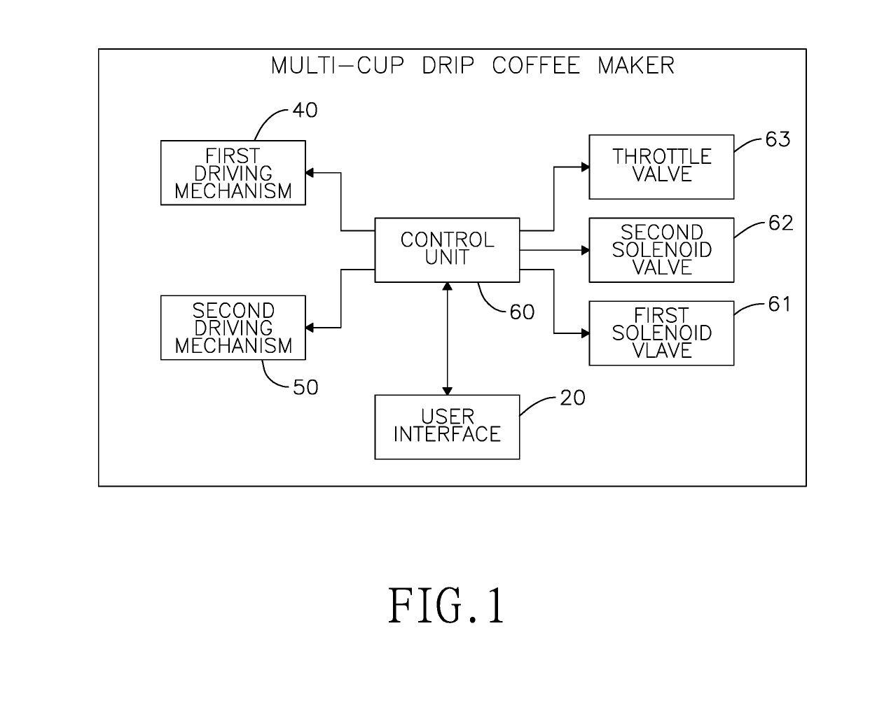

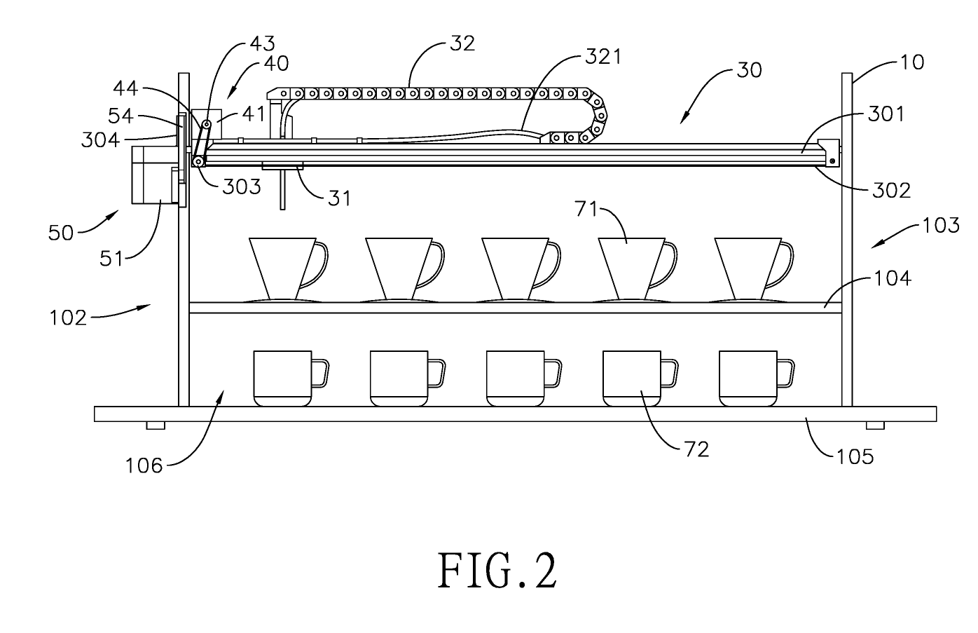

With reference to FIGS. 1 and 2, a multi-cup drip coffee maker in accordance with the present invention includes a casing 10, a user interface 20, a displacing mechanism 30, a first driving mechanism 40, a second driving mechanism 50 and a control unit 60. The control unit 60 is electrically connected to the user interface 20, the first driving mechanism 40 and the second driving mechanism 50.

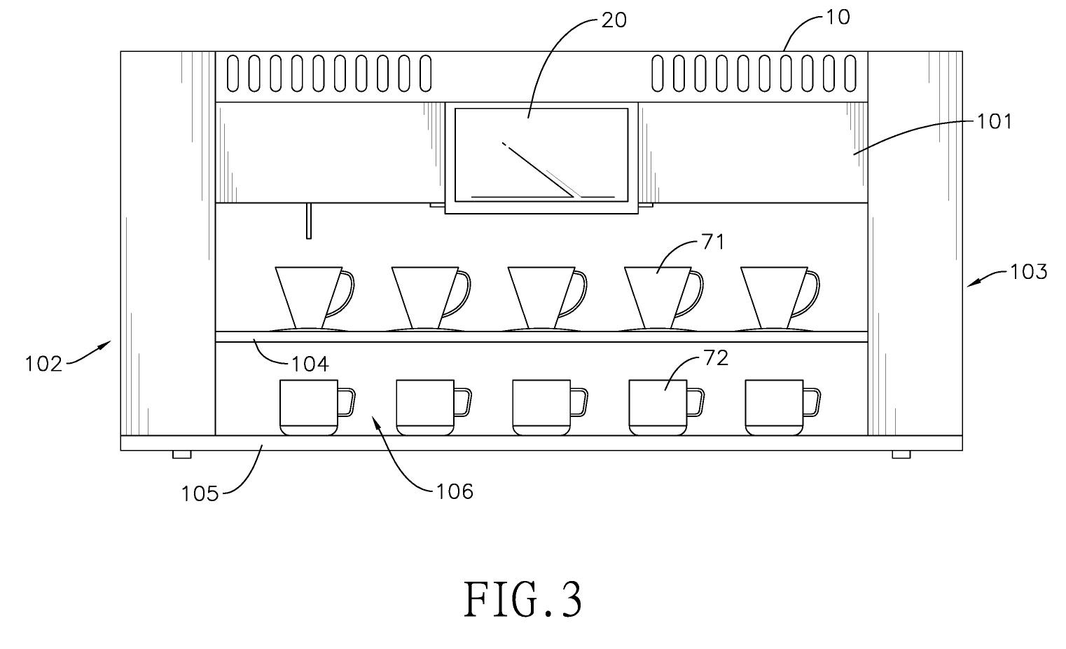

With reference to FIGS. 2 and 3, to describe the structure of the casing 10, the casing 10 has a front panel 101, a rear panel, a first side panel 102, a second side panel 103, a filtering cup shelf 104 and a base shelf 105. The first side panel 102 is opposite to the second side panel 103. The front panel 101 is oriented toward the front and faces users. The rear panel is oriented toward the rear. The user interface 20 is mounted on the front panel 101 of the casing 10 to facilitate users' operation thereon. When users face the user interface 20, the first side panel 102 is located to the left of the casing 10, and the second side panel 103 is located to the right of the casing 10. A receiving chamber 106 is formed through the front panel 101 and the rear panel and is defined between the first side panel 102 and the second side panel 103. The filtering cup shelf 104 is mounted inside the receiving chamber 106 with both ends thereof securely connected with inner walls of the first side panel 102 and the second side panel 103 respectively to divide the receiving chamber 106 into a first space and a second space. The first space is defined between the filtering cup shelf 104 and a bottom surface of the front panel 101 for accommodating one or more filtering cups 71 placed on the filtering cup shelf 104. The second space is defined between the filtering cup shelf 104 and the base shelf 105 for accommodating one or more cups 72 placed on the base shelf 105 and corresponding to the one or more filtering cups, such that coffee drips through the one or more filtering cups 71 is collected in the respective cups 72.

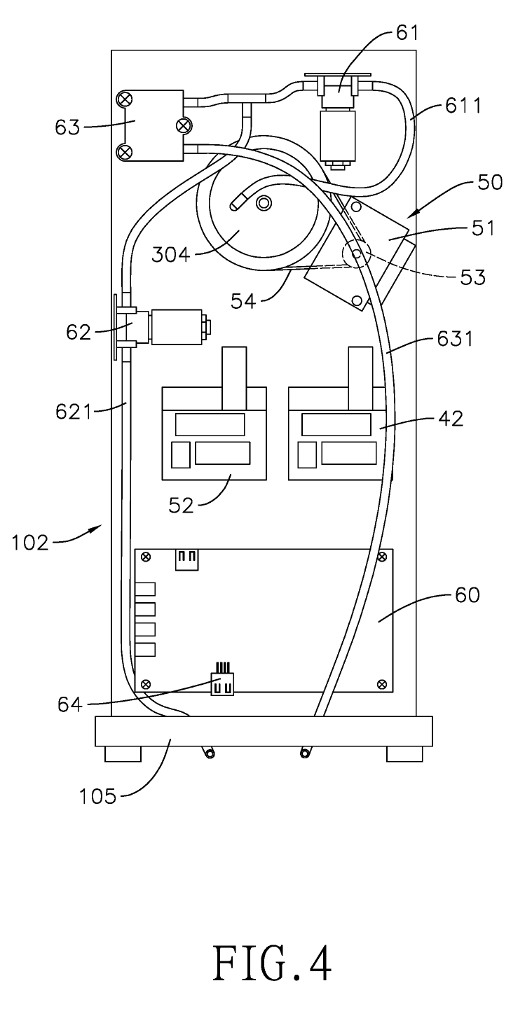

With reference to FIGS. 2 and 4, the displacing mechanism 30 is mounted inside an area surrounded by the front panel 101, the rear panel, the first side panel 102 and the second side panel 103, is located above the first space with two ends of the displacing mechanism 30 pivotally mounted on the inner walls of the first side panel 102 and the second side panel 103, and has a coffee outlet seat 31 movably mounted thereon to be movable between the first side panel 102 and the second side panel 103.

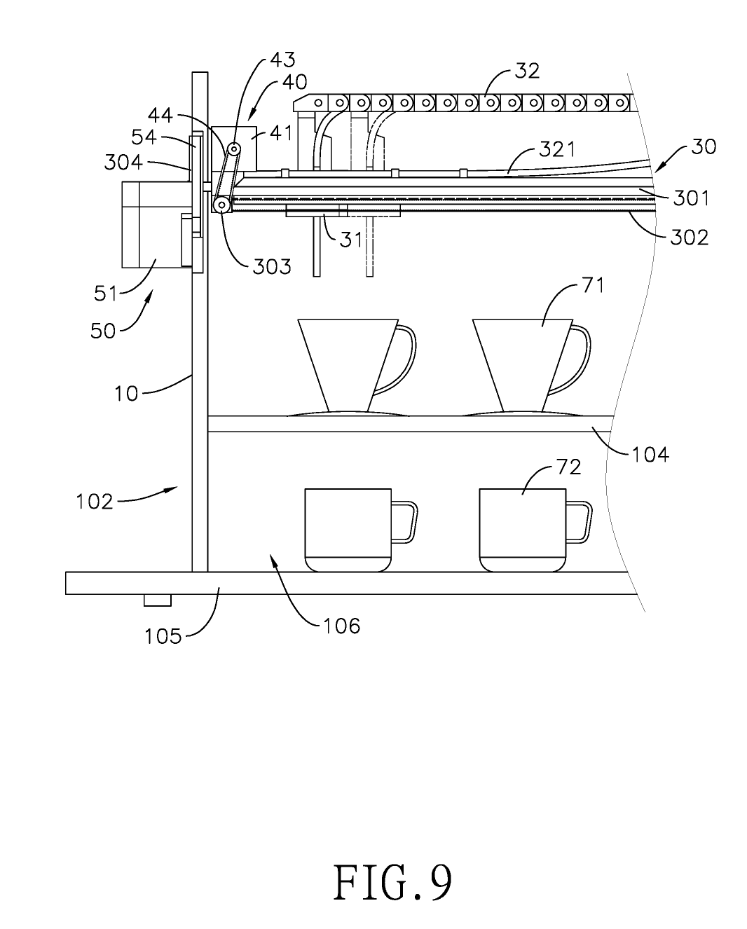

In the present embodiment, the displacing mechanism 30 includes a sliding track 301, a first timing belt 302, a first timing pulley 303 and a second timing pulley 304. Two ends of the sliding track 301 are pivotally mounted on the inner walls of the first side panel 102 and the second side panel 103. The first timing pulley 303 is mounted on a front portion of the sliding track 301 and is located on the end of the sliding track 301 that faces the first side panel 102. With joint reference to FIG. 9, the first timing belt 302 is loop-shaped and is mounted around the sliding track 301. The second timing pulley 304 is mounted on an outer wall of the first side panel 103 and is pivotally connected to the end of the sliding track 301 that faces the first side panel 102. The coffee outlet seat 31 is mounted on the first timing belt 302 and is movable between the first side panel 102 and the second side panel 103 when the first timing belt 302 is rotated.

In the present embodiment, the displacing mechanism 30 further has a hose retaining member 32 mounted on the sliding track 301. The hose retaining member 32 has a first hose 321 retained therein with one end of the first hose 321 connected to the coffee outlet seat 31. When the coffee outlet seat 31 is moved, the first hose 321 is prevented from falling off and being clogged or entangled. The hose retaining member 32 may be a hollow chain with the first hose 321 mounted inside the chain.

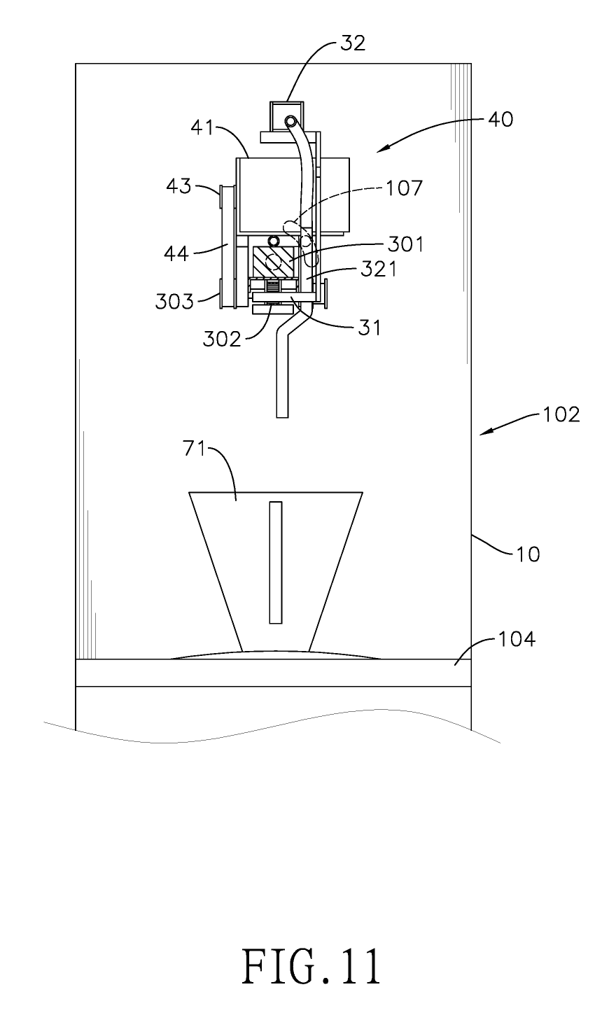

With reference to FIGS. 2 and 11, the first side panel 102 further has an arced slot 107 formed in the inner wall of the first side panel 102. The end of the sliding track 301 mounted in the first side panel 103 is mounted in the arced slot 107 for the sliding track 301 to be kept in an oscillating range when the sliding track 301 is oscillated forward and backward for assurance of stability.

With reference to FIGS. 2 and 4, the first driving mechanism 40 is mounted on the inner wall of the first side panel 102, is connected with the displacing mechanism 30, and includes a first motor 41, a first motor drive 42, a third timing pulley 43 and a second timing belt 44. The first motor 41 is mounted on the inner wall of the first side panel 102. The third timing pulley 43 is mounted around a spindle of the first motor 41 and is axially parallel to the first timing pulley 303. The second timing belt 44 is mounted around the first timing pulley 303 and the third timing pulley 43. The first motor drive 42 is mounted on an outer wall of the first side panel 102 and is electrically connected to the first motor 41 and the control unit 60.

When the first motor 41 rotates, the third timing pulley 43 is driven to rotate, the second timing belt 44 is driven to drive the first timing pulley 303 to rotate, and the first timing belt 302 is driven to displace so as to move the coffee outlet seat 31 leftward and rightward.

The second driving mechanism 50 is mounted on the outer wall of the first side panel 102, is pivotally connected with the displacing mechanism 30, and includes a second motor 51, a second motor drive 52, a fourth timing pulley 53, and a third timing belt 54. The second motor 51 is mounted on the outer wall of the first side panel 102. The second motor drive 52 is mounted on the outer wall of the first side panel 102 and is electrically connected to the second motor 51 and the control unit 60. The fourth timing pulley 53 is mounted around a spindle of the second motor 51 and is axially parallel to the second timing pulley 304. The third timing belt 54 is mounted around the second timing pulley 304 and the fourth timing pulley 53.

When the second motor 51 rotates, the fourth timing pulley 53 is rotated, the third timing belt 54 is driven to drive the second timing pulley 304 to rotate, and the sliding track 301 is driven to oscillate forward and backward.

With reference to FIGS. 1 and 4, the control unit 60 is electrically connected to the user interface 20, the first motor drive 42 and the second motor drive 52. With joint reference to FIG. 3, the control unit 60 configures multiple positioning points along a longitudinal direction of the filtering cup shelf 104 with each positioning point corresponding to a location for a corresponding filtering cup 71 to be placed. In the present embodiment, there are five positioning points to correspond to five locations for five filtering cups to be placed thereon. The first one of the five positioning points is defined to be the one most adjacent to the first side panel 102. The remaining positioning points along the longitudinal direction of the filtering cup shelf 104 are the second, third, fourth and fifth positioning points sequentially. The control unit 60 transmits a driving signal to the first motor drive 42 to drive the first motor 41 to rotate, such that the coffee outlet seat 31 is moved to any one of the multiple positioning points. Alternatively, the control unit 60 sends a driving signal to the second motor drive 52 to drive the second motor 51 to rotate, such that the displacing mechanism 30 is driven to oscillate forward and backward.

In the present embodiment, the first driving mechanism 40 needs to drive the displacing mechanism 30 to move the coffee outlet seat 31 between the first side panel 102 and the second side panel 103 until the coffee outlet seat 31 is aligned with the positioning point of a corresponding filtering cup 71, to oscillate the coffee outlet seat 31 with respect to the positioning point, or to both move and oscillate the coffee outlet seat 31.

In the present embodiment, the multi-cup drip coffee maker further includes a first two-way solenoid valve 61, a second two-way solenoid valve 62 and a two-way throttle valve 63. The first two-way solenoid valve 61, the second two-way solenoid valve 62 and the two-way throttle valve 63 are electrically connected to the control unit 60. One port of the first two-way solenoid valve 61 is connected to the other end of the first hose 321, and the other port of the first two-way solenoid valve 61 is connected to one port of the two-way throttle valve 63 through a second hose 611 and one port of the second two-way solenoid valve 62. The other port of the second two-way solenoid valve 62 is connected to a third hose 621 to evacuate cold water. The other port of the two-way throttle valve 63 is connected to a fourth hose 631 and is connected to a hot water supplier through the fourth hose 631.

In the present embodiment, the first two-way solenoid valve 61 controls hot water to flow into the coffee outlet seat 31. The two-way throttle valve 63 serves to control a flow rate of hot water flowing in. The second two-way solenoid valve 62 serves to evacuate cold water retained in the hoses.

During operation, the control unit 60 sends a signal to activate the two-way throttle valve 63 and the first two-way solenoid valve 61, such that hot water flows to the coffee outlet seat 31 through the fourth hose 631, the two-way throttle valve 63, the first two-way solenoid valve 61 and the first hose 321. With further reference to FIG. 2, hot water is then filled in a corresponding filtering cup 71 through the coffee outlet seat 31.

After the multi-cup drip coffee maker stays idle for a while, water in the hoses may become cold. Hence, the control unit 60 sends another signal to activate the second two-way solenoid valve 62 for cold water to be evacuated through the first hose 321, the first two-way solenoid valve 61, the second hose 611, the second two-way solenoid valve 62 and the third hose 621.

In the present embodiment, the control unit 6 further has a communication port 64 for connection with a wired network. Thus, the multi-cup drip coffee maker can be connected to a server through the Internet for software upgrade.

To elaborate the user interface 20, with reference to FIG. 1, the user interface 20 has an operating system (Android) installed therein and has an application installed therein for coffee brew configuration. The application provides an operation interface including a menu module 21. The menu module 21 has a brewing control mode 22, a recipe setting mode 23 and a version upgrade mode 24. In the present embodiment, the application can be upgraded through the version upgrade mode 24. With further reference to FIG. 4, the communication port 64 of the control unit 60 is connected to the server for upgrading the application.

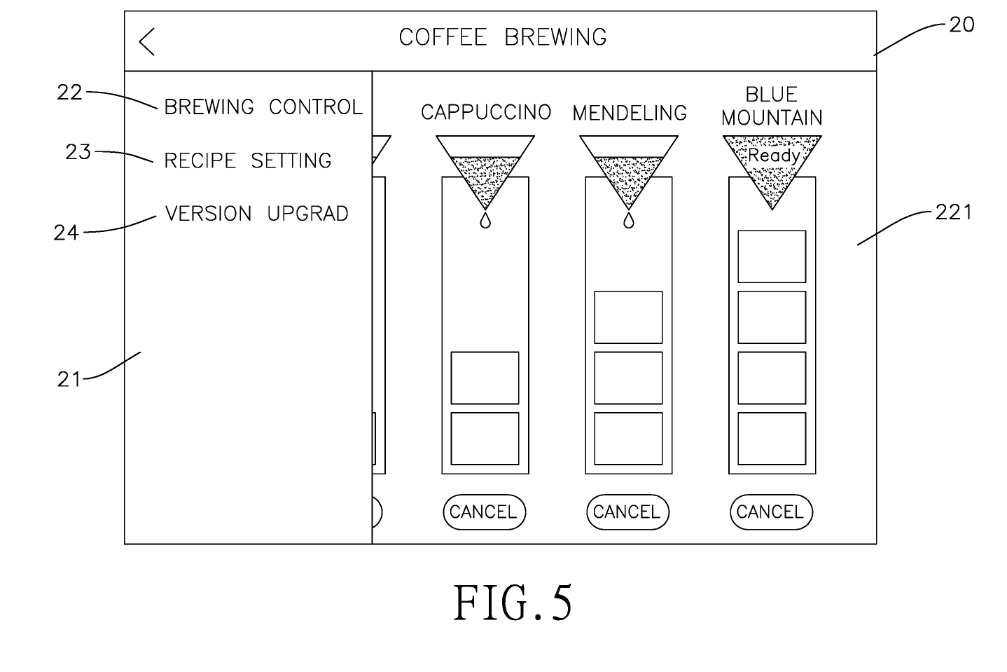

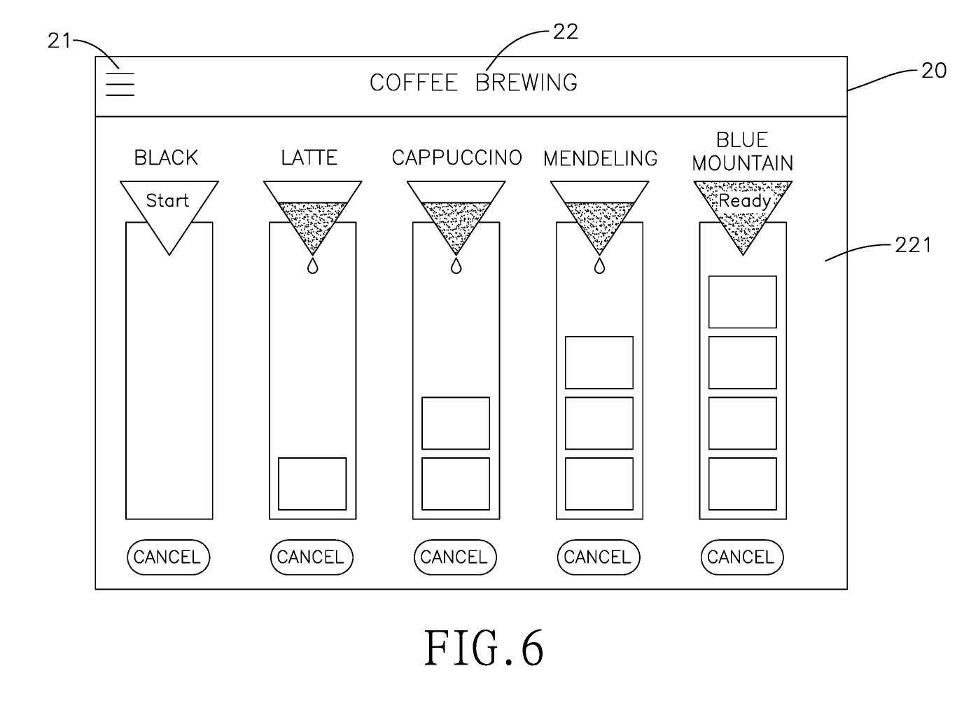

With reference to FIGS. 5 and 6, the brewing control mode 22 provides a brewing control page 221 for activation/deactivation of coffee brewing, selection of type of coffee at a corresponding location, and display of amount of water for brewing coffee. With joint reference to FIG. 3, as the five positioning points on the filtering cup shelf 104 correspond to the respective five filtering cups 71, the brewing control page 221 provides control over coffee brewing at the five positioning points.

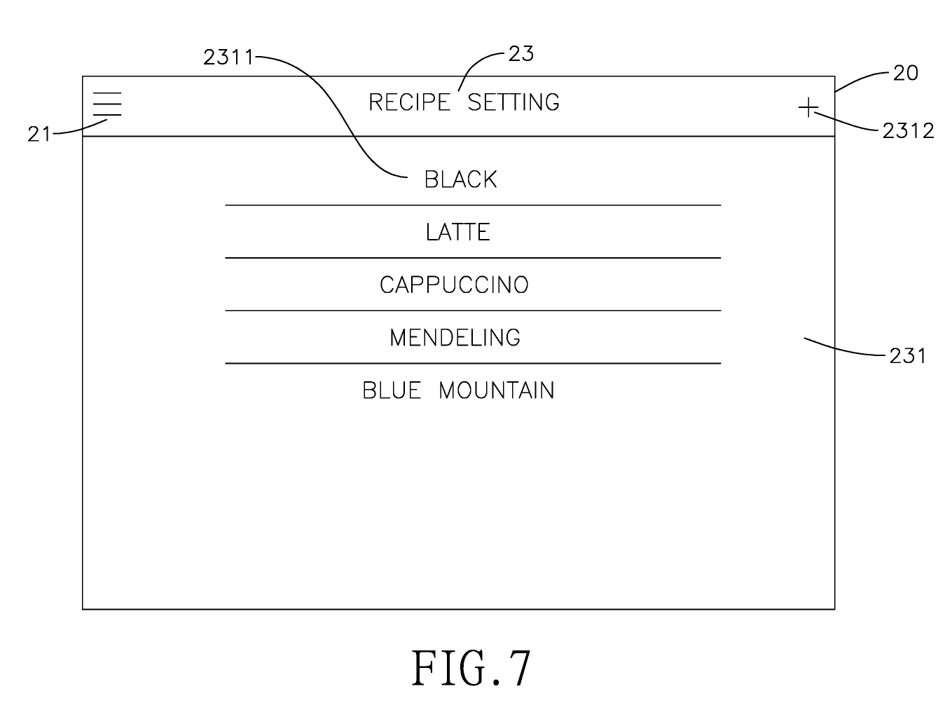

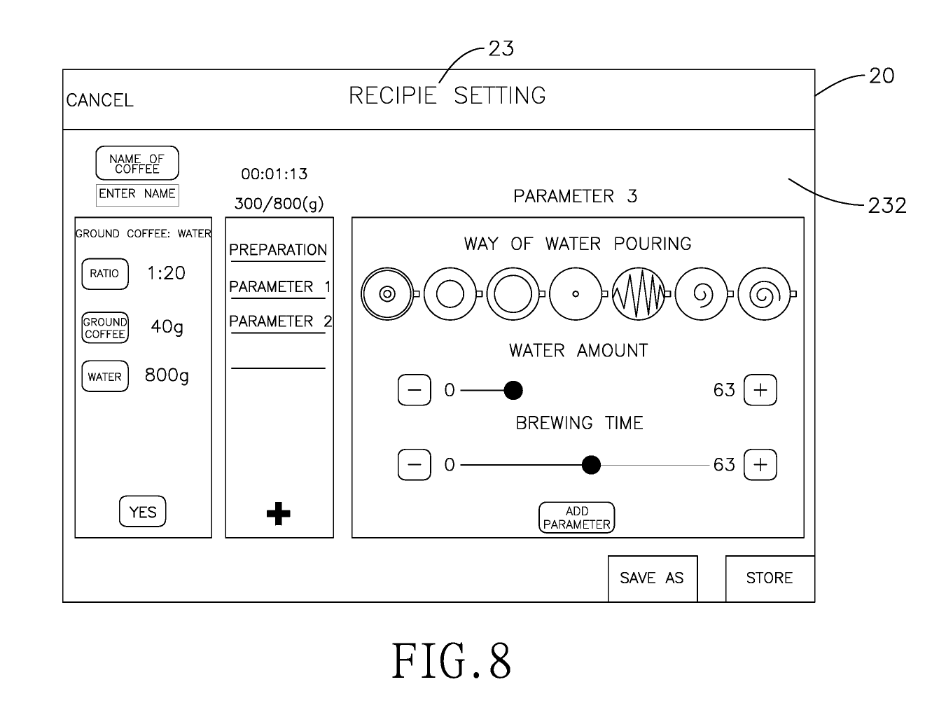

With reference to FIGS. 7 and 8, the recipe setting mode 23 provides a recipe selection page 231 and a recipe edit page 232. The recipe selection page 231 includes a coffee type selection list 2311 and a coffee type addition button 2312. After the type of coffee is selected by selecting an option in the coffee type selection list 2311 or is selected from a newly added type of coffee through input using the coffee type addition button 2312, users can further enter the recipe edit page 232. When entering the recipe edit page 232, users can configure a ratio of coffee to water, water pouring method, amount of water poured, and brew cycle time in the recipe edit page 232.

To elaborate operation of the multi-cup drip coffee maker, with reference to FIGS. 1, 3, 6 and 9, after configuring the type of coffee to be brewed and a corresponding recipe through the user interface 20, users can perform the coffee brewing operation on the user interface 20 under the brewing control mode 22. As shown on FIG. 6, when a start button corresponding to black coffee at the first positioning point is started, the user interface 20 sends a configuration signal to the control unit 60, and the control unit 60 then sends a corresponding driving signal to the first motor 41 or the second motor 51 for the first motor 41 or the second motor 51 to rotate according to the configuration signal. Specifically, suppose that the black coffee is brewed by way of shaking the coffee outlet seat 31 left and right within a range of a top opening of the filtering cup 71 for brewing the black coffee. The control unit 60 controls the first motor 41 to rotate to move the coffee outlet seat 31 to be directly aligned with and located above the first positioning point corresponding to the filtering cup 71 for the black coffee, such that the coffee outlet seat 31 is shaken left and right within the range of the top opening of the filtering cup 71, hot water is poured into the filtering cup 71, and drip coffee is collected in a corresponding cup 72.

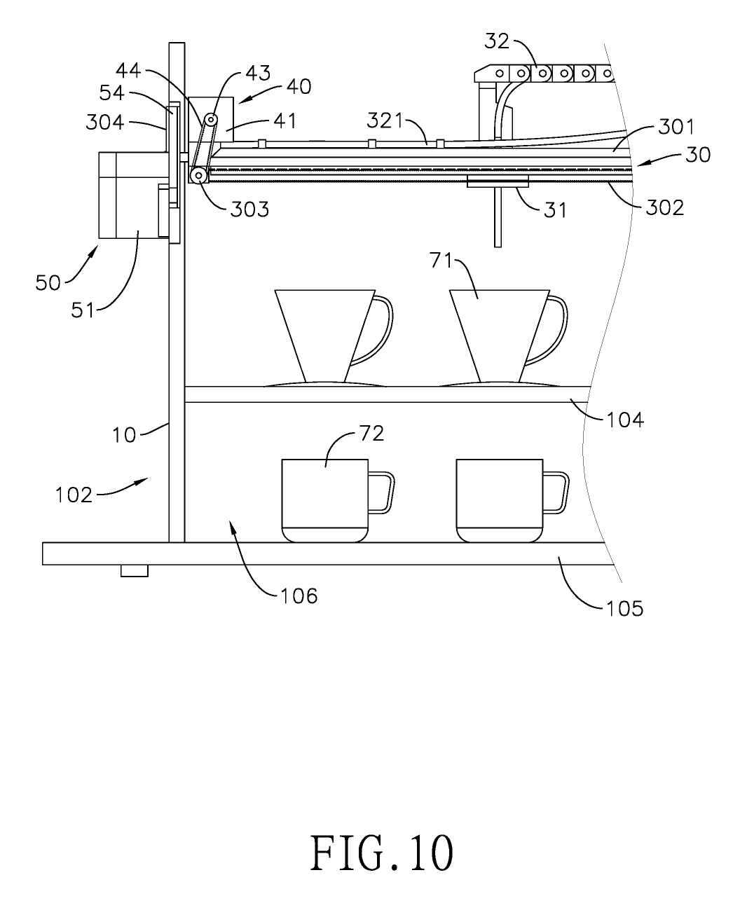

After hot water is filled in the multi-cup drip coffee maker, with reference to FIGS. 1 and 10, the control unit 60 further transmits a driving signal to drive the first motor 41 to rotate and move the coffee outlet seat 31 right above the filtering cup 71 corresponding to the second positioning point, and hot water is poured into the filtering cup 71 corresponding to the second positioning point.

In the present embodiment, the application includes a coffee brewing optimization function, which calculates a coffee brewing time and a wait time for coffee filtering to generate an optimization mode for best brewing sequence, thereby optimizing coffee brewing time and raising coffee brewing efficiency.

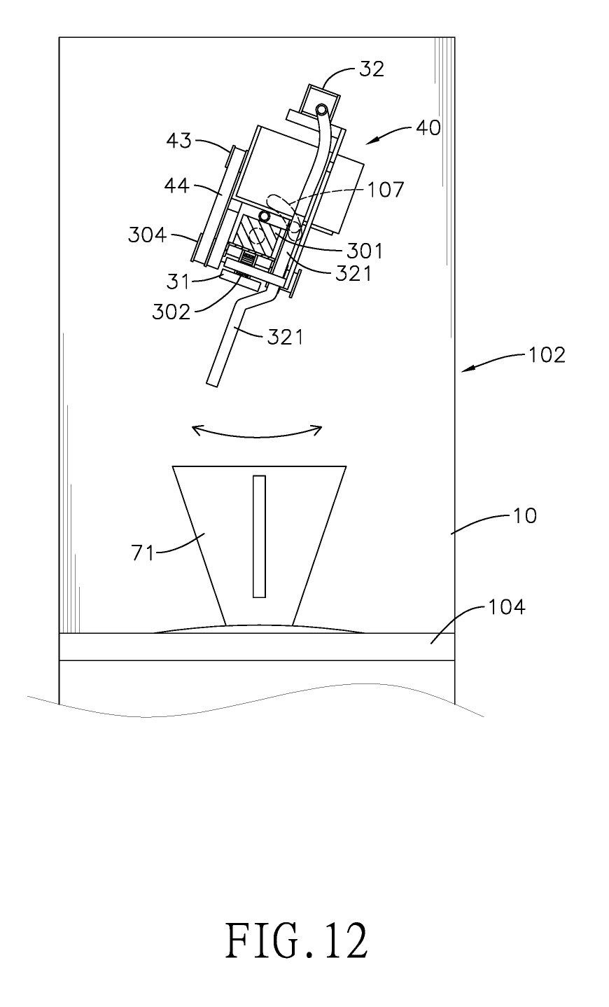

Suppose that the coffee outlet seat 31 is moved to be right above next filtering cup 71 and the coffee selected is brewed by way of oscillating forward and backward. With reference to FIGS. 4 and 11, the second motor 51 is rotated to drive the sliding track 301 to oscillate forward and backward by sequentially driving the fourth timing pulley 53, the third timing belt 54 and the second timing belt 44. With further reference to FIG. 12, when the sliding track 301 is oscillated forward and backward to drive the coffee outlet seat 31 to move with it, hot water is poured into the filtering cup 71 by way of forward and back oscillation.

Besides, in the present embodiment, coffee brewing can be performed by pouring hot water in a helical manner, which involves simultaneous operation of the first driving mechanism 40 and the second driving mechanism 50, allowing the coffee outlet seat 31 to be moved in a helical manner.

In sum, the present invention has the following advantages:

1. Users can configure multiple ways of pouring hot water for coffee brewing to achieve convenient operation.

2. Continuous brewing of multiple cups of coffee with enhanced brewing efficiency.

3. By virtue of the optimization mode for best brewing sequence in the user interface 20, the multi-cup drip coffee maker can arrange an optimized brewing sequence upon brewing multiple cups of coffee according to the ways of pouring hot water for coffee brewing and the wait time to reduce brewing time and increase brewing efficiency.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A multi-cup drip coffee maker comprising:
a casing having:
a front panel;
a first side panel;
a second side panel opposite to the first side panel;
a receiving chamber defined between the first side panel and the second side panel; and
a filtering cup shelf mounted inside the receiving chamber;
a user interface mounted on the front panel;
a displacing mechanism pivotally mounted on inner walls of the first side panel and the second side panel and having a coffee outlet seat movably mounted on the displacing mechanism to be moveable between the first side panel and the second side panel;
a first driving mechanism mounted on the inner wall of the first side panel and connected with the displacing mechanism to drive the displacing mechanism and the coffee outlet seat to be movable left and right between the first side panel and the second side panel;
a second driving mechanism mounted on an outer wall of the first side panel, and pivotally connected with the displacing mechanism to drive the displacing mechanism and the coffee outlet seat to oscillate forward and backward;
a control unit mounted on the outer wall of the first side panel, and electrically connected to the user interface, the first driving mechanism and the second driving mechanism, configuring multiple positioning points along a longitudinal direction of the filtering cup shelf with each positioning point corresponding to a location for a corresponding filtering cup to be placed, receiving a configuration signal sent from the user interface, and transmitting a driving signal to the first driving mechanism according to the configuration signal to drive the first driving mechanism to operate to drive the displacing mechanism for the displacing mechanism to drive the coffee outlet seat to move to any one of the multiple positioning points or transmitting another driving signal to drive the second driving mechanism to operate to drive the displacing mechanism for the displacing mechanism to drive the coffee outlet seat to oscillate forward and backward with respect to a corresponding positioning point.

2. The multi-cup drip coffee maker as claimed in claim 1, wherein the displacing mechanism includes:
a sliding track with two ends thereof pivotally mounted on the inner walls of the first side panel and the second side panel;
a first timing belt mounted around the sliding track, wherein the coffee outlet seat is mounted on the first timing belt and is movable between the first side panel and the second side panel when the first timing belt is rotated;
a first timing pulley mounted on a front portion of the sliding track and located on the end of the sliding track facing the first side panel; and
a second timing pulley mounted on the outer wall of the first side panel and pivotally connected to the end of the sliding track facing the first side panel.

3. The multi-cup drip coffee maker as claimed in claim 2, wherein the displacing mechanism further has a hose retaining member mounted on the sliding track and having a first hose retained therein with one end of the first hose connected to the coffee outlet seat.

4. The multi-cup drip coffee maker as claimed in claim 3, wherein the first driving mechanism includes:
a first motor mounted on the outer wall of the first side panel;
a first motor drive mounted on the outer wall of the first side panel and electrically connected to the first motor and the control unit;
a third timing pulley mounted around a spindle of the first motor and being axially parallel to the first timing pulley; and
a second timing belt mounted around the first timing pulley and the third timing pulley.

5. The multi-cup drip coffee maker as claimed in claim 4, wherein the second driving mechanism includes:
a second motor mounted on the outer wall of the first side panel;
a second motor drive mounted on the outer wall of the first side panel and electrically connected to the second motor and the control unit;
a fourth timing pulley mounted around a spindle of the second motor and being axially parallel to the second timing pulley; and
a third timing belt mounted around the second timing pulley and the fourth timing pulley.

6. The multi-cup drip coffee maker as claimed in claim 5, further comprising a first two-way solenoid valve, a second two-way solenoid valve and a throttle valve electrically connected to the control unit, wherein one port of the first two-way solenoid valve is connected to the other end of the first hose and the other port of the first two-way solenoid valve is connected to one port of the two-way throttle valve through a second hose and one port of the second two-way solenoid valve, the other port of the second two-way solenoid valve is connected to a third hose, and the other port of the two-way throttle valve is connected to a fourth hose.

7. The multi-cup drip coffee maker as claimed in claim 2, wherein the first side panel has an arced slot formed in the inner wall of the first side panel for the end of the sliding track mounted in the first side panel to be mounted in the arced slot.

8. The multi-cup drip coffee maker as claimed in claim 1, wherein the control unit further has a communication port.

9. The multi-cup drip coffee maker as claimed in claim 1, wherein the user interface provides an operation interface including a menu module, wherein the menu module has a brewing control mode, a recipe setting mode and a version upgrade mode.

10. The multi-cup drip coffee maker as claimed in claim 9, wherein the recipe setting mode provides a recipe selection page and a recipe edit page, the recipe selection page includes a coffee type selection list and a coffee type addition button, and the brewing control mode provides a brewing control page.
